(19) United States
(12) Patent Application Publication
(10) Pub. No.: US 2017/0215008 A9
(43) Pub. Date: Jul. 27, 2017

(54) MULTI-DIRECTIONAL HIGH-EFFICIENCY PIEZOELECTRIC ENERGY TRANSDUCER

(71) Applicants: Zhengbao Yang, Toronto (CA); Jean W. Zu, Toronto (CA)

(72) Inventors: Zhengbao Yang, Toronto (CA); Jean W. Zu, Toronto (CA)

(21) Appl. No.: 14/297,029

(22) Filed: Jun. 5, 2014

Related U.S. Application Data
(60) Provisional application No. 61/837,727, filed on Jun. 21, 2013.

(51) Int. Cl. H04R 17/00

(52) U.S. Cl. CPC H04R 17/00

(57) ABSTRACT

A piezoelectric transducer for harvesting ambient vibration energy is made up of two elastic beams poled for series operation, a center flextensional component and two proof masses. The center flextensional component serves as the energy harvesting part as well as vibration harvesting inertial mass. The energy harvester is capable of harvesting multi-directional low-frequency vibration energy efficiently. It can be applied in implantable devices, wearable electronics and wireless sensor networks.

### RELATED APPLICATION

The present invention was first described in U.S. Provisional Patent No. 61/837,727 filed on Jun. 21, 2013.

### FIELD OF THE INVENTION

The invention relates generally to energy harvesting from ambient vibration.

### DESCRIPTION OF RELATED ART

Communication devices, sensor networks, wearable electronics, implantable devices, etc. play increasingly important role in modern life. Those electronics are usually small, compact and need to have a long lasting power source. For instance, the forest fire monitoring system that consists of a very large number of sensors distributed over a large area, replacement or maintenance of such a large number of batteries is extremely pricy and time-consuming. In response to the urgent need to develop lightweight power supplies having high energy density and long lifetime, the present invention provides a self-powered solution.

The available self-powered solutions are based on utilizing various types of external sources such as solar power, heat or mechanical vibration. Among them, vibration energy is one that is weather-independent and ubiquitous. There are mainly three energy conversion methods used in vibration-based energy harvesters: electromagnetic, electrostatic and piezoelectric conversion methods. Methods that use the piezoelectric effect have the advantage of being easy to scale, not having a separate voltage source, and having high energy density. Besides, piezoelectric materials can be easily incorporated into many systems that are subjected to dynamic energy.

A prior art devices using piezoelectric energy harvesting are based on the cantilever configuration, which consists of an inertial mass at the tip end of a cantilever beam and piezoelectric materials mounted on the cantilever. This type of system has relatively low resonance frequency but poor energy output. Due to its weak mechanical strength, these kind of energy harvesters operating in bending mode can easily develop line cracks in piezoelectric materials. Some systems use cymbal configurations, which composes of an inertial mass, two end-caps and piezoelectric materials sandwiched by the two caps. They utilize flextensional amplification mechanism to amplify stress to cater to the characteristics of piezoelectric materials, i.e. large ultimate stress but extremely small ultimate strain. But the cymbal is efficient only when the applied load is very big. Besides, the resonance frequency of cymbal configurations is far higher than that of excitation sources, which is detrimental to the efficiency of energy harvesters. See, e.g., U.S. Patent Application 2005/0134149 A1 U.S. Pat. No. 3,277,433 (1966) William J. Toulis, and “Energy harvesting with a cymbal type piezoelectric transducer from low frequency compression.” Journal of electroceramics 28.4 (2012): 214-219.

Energy transfer from the ambient environment to the electric load is maximized only in a small region of the excitation frequency spectrum. When the excitation is in the vicinity of the resonance frequency of the system, the system resonates and so vibration energy is captured as much as possible. Therefore, energy harvesters should be designed working around resonance frequencies of excitation sources.

Frequencies of ambient vibration sources are usually below 300 Hz according to previous statistics (N. E. Dutoit, B. L. Wardle, S. G. Kim, “Design Considerations for MEMS-Scale Piezoelectric Mechanical Vibration Energy Harvesters,” Integrated Ferroelectrics, 71: 121-160, 2005), while that of human motions is typically less than 100 Hz. However resonance frequencies of traditional energy harvesters adopted flextensional structures like cymbal, moonie, are typically more than 1K Hz (R. E. Newnham, et al., “Size Effects in Capped Ceramic Underwater Sound Projectors”, OCEANS '02 MTS/IEEE, vol. 4, 2315-2321, 2002), besides the desired vibration shape is not the first mode shape, which means the resonance frequency of excitation sources should be even higher than the first resonance frequency of the energy harvesting system.

Typical energy harvesters, like bimorph cantilever, cymbal or their derived structures suffer from significant attenuation of power response if vibration sources do not vibrate in the pre-designed transverse direction. While vibration sources like human motion, machine vibration are not always kept in a fixed direction. They are usually composed of several motions in different directions and change along with time and circumstances varying. So it is an essential property for a vibration-based energy harvester to be able to harvest multi-direction vibration energy.

### SUMMARY OF THE INVENTION

To tackle foregoing drawbacks of current energy harvester, the present “multi-directional high-efficiency piezoelectric energy transducer” is invented to harvest low-frequency, low-acceleration vibration energy from multi-directions. It takes full advantage of the multistage force amplification mechanism developed in it and the characteristic of low resonance frequency of elastic beams. The advantages of the invention can be concluded as follows:
1. High efficiency: a new multistage force amplification mechanism is developed in this device so that high-efficiency mechanical-electrical energy conversion is achieved. The invention can generate orders of magnitude more energy than the traditional flextensional energy harvesters under same conditions;
2. Good durability: Most energy harvesters work in the bending mode, which can easily induce cracks and fatigue in piezoelectric materials after several cycles. However the piezoelectric component of this invention works in compressive mode, which is over 10 times stronger than other operation modes. The existence of bow-shaped metal plates also protect the piezoelectric element from failure to a certain extent. So it has good durability and reliability;
3. Capability of harvesting vibration energy from multi-directions;
4. Low resonance frequency: the resonance frequency can be adjusted to under 100 Hz to match ambient excitation sources; and
5. Broad working bandwidth: Nonlinear mechanism can be introduced into the system to get broader bandwidth. The structure itself shows strong intrinsic nonlinearity. The nonlinearity can also be further enhanced by adding axial preload or adopting nonlinear elastic beams or a magnetic field.

The present device consists of two elastic beams poled for series operation, two proof masses and a center flextensional component. The elastic beams change the vibration direction to axial direction and at the same time amplify the induced force. Then the amplified force is magnified further in the center flextensional component. The accumulated amplification mechanism and the property of low resonance frequency of beams are synthesized subtly in this invention so that the proposed device is able to harvest low-frequency weak vibration energy efficiently.

The aforementioned objectives of the present invention are attained by two elastic beams poled for series operation, two proof masses and a center flextensional component. Other objectives, advantages and novel features of the present invention will become readily apparent from the following drawings and detailed description of preferred embodiments.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 is a functional block diagram of the multi-direction high-efficiency energy harvesting device in accordance with the present invention;

FIG. 2 shows a schematic view of the present invention;

FIGS. 3A-B are diagrams depicting multistage amplification mechanism, where FIG. 3A shows how the first amplification structure (elastic beams) functions and FIG. 3B shows how the second amplification structure (center flextensional component) functions;

FIG. 4 is a different embodiment of the elastic beams, which can be a uniform beam, a curved beam, a spring or other geometries that can provide needed elastic force, wherein the nonlinear spring or super-elastic materials (for example: Nitinol) can be used to improve the performance;

FIG. 5 is a different embodiment of the flextensional components, listing three possible structures that apply the amplification mechanism;

FIG. 6 is the schematic diagram showing multi-flextensional centers working in series;

FIG. 7 is the schematic diagram showing multi-flextensional centers working in parallel;

FIG. 8 shows traditional flextensional harvester;

FIG. 9 shows a high efficiency vibration energy harvester with a base to fix on a shaker;

FIG. 10 shows electrical response of the high-efficient energy harvesting device under 0.5 g acceleration, connected to a resistor of 300 KO; and

FIG. 11 shows the performance comparison between the present invention and the conventional energy harvester.

### DETAILED DESCRIPTION OF PREFERRED EMBODIMENTS

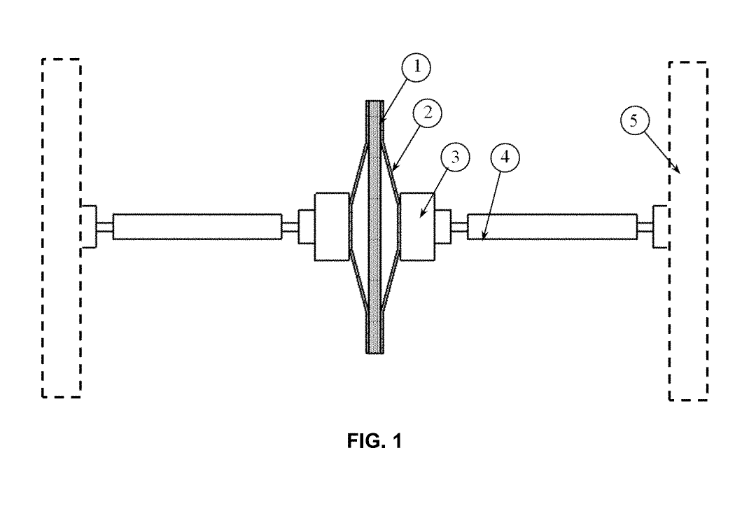

FIG. 1 shows a functional block diagram of the multi-directional high-efficiency energy harvesting device in accordance with the present invention. The device includes a center flextensional component comprising of piezoelectric materials 1 and a pair of bow-shaped plates 2, two proof mass 3, two elastic beams 4 and a base 5. The base 5 is used to fix the device and it can be anything in practice, like a bridge, an airplane, a vehicle or a pacemaker, etc.

The employed piezoelectric material 1 can be piezoceramics like PZT, PVDF, quartz, single crystal materials, like PMN-PT or others that have high piezoelectric constants and high electromechanical coupling constants or magnetostrictive materials. The configurations can be one-layer unimorph, two-layer bimorph or multi-layer stack. It can work at different mode piezoelectric effects (d₃₁, d₃₃, d₁₅ and so on).

Bow-shaped metal plates 2 serve as mechanical transformers for transforming and amplifying a portion of the incident axial stress in the radial stresses of opposite sign. So the material of the plate is selected carefully to improve the strength of the structure and match the mechanical impedance.

The multi-directional energy transducer widens the working bandwidth and improves efficiency at the same time. Besides, it solves the problem existing in most energy harvesters: significant attenuation of power output when the vibration sources are not in the pre-set direction.

The ambient vibration in environment is usually in a wide range of frequency; thus vibration-based energy harvesters should be designed to have a wide working bandwidth to accommodate to the frequency-varying excitations. Introducing nonlinearity into an energy harvesting system is a feasible way to widen the bandwidth. In this invention, utilizing an axial preload to soften or stiffen the structure can broaden the working bandwidth as well as tune resonance frequency Nonlinearity can also be introduced by a magnetic field, nonlinear springs or super elastic materials.

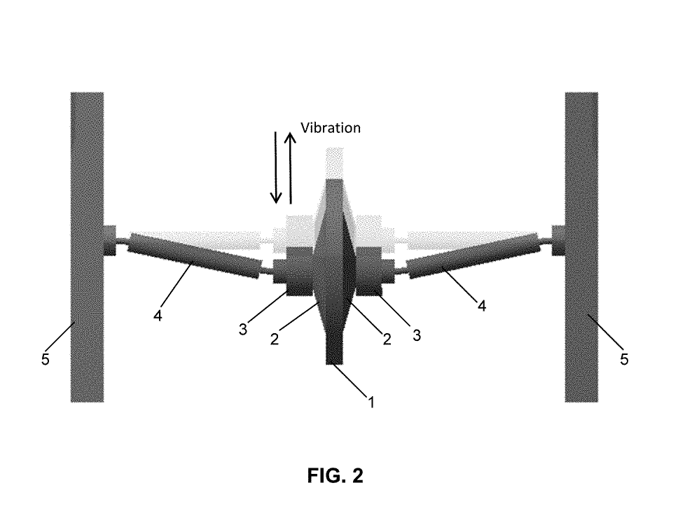

FIG. 2 shows a schematic view of the present invention. The device can harvest vibrations from multi-directions. The vibration can be induced by base excitation, by direct excitation on center component or by other achievable methods according to different operation conditions.

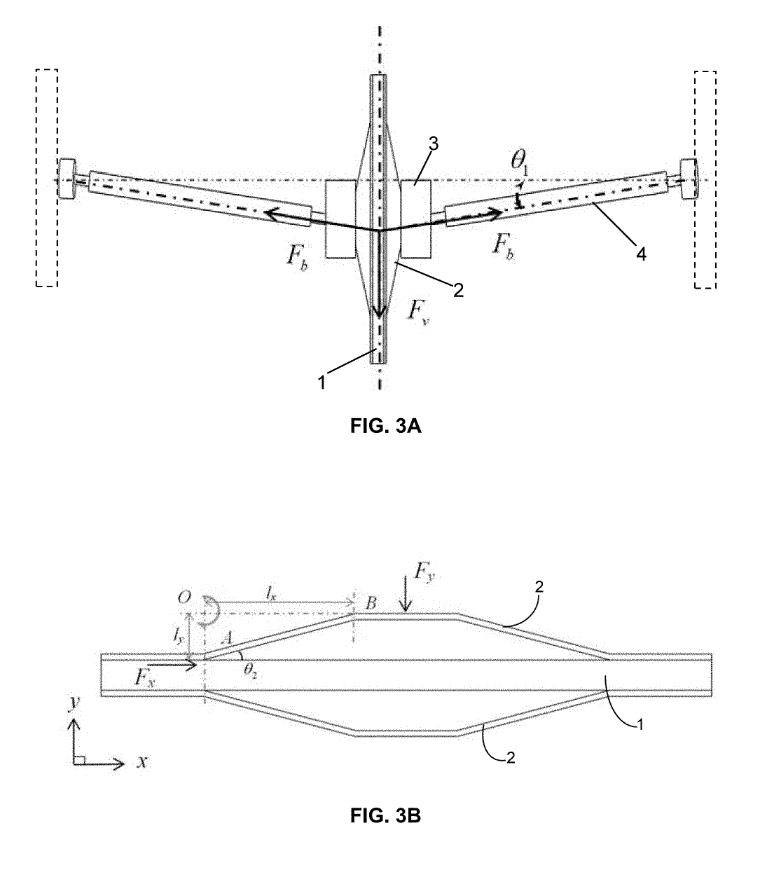

The multistage force amplification mechanism is illustrated in FIG. 3. The angle of the oblique elastic beam 4 to the horizontal line: θ₁ is induced by vibration. The angle of the bow-shaped plate 2: θ₂ is carefully determined according the circumstance to get the highest energy output as well as to avoid possible damage. The angle θ₂ also alters as the device vibrates.

As for the first amplification structure, i.e. the elastic beams, the relation between the force induced by vibration, Fᵥ, and the axial force along beams, F_{b}, can be expressed as follows:

2×sin θ₁×F_{b}=Fᵥ [Equation 1]

The input force for the second amplification structure (center flextensional component) F_{y} is perpendicular to concave metal plate, and F_{y}=F_{b} cos θ₁. So, the first amplification ratio can be derived as:

$${R}_{1} = \frac{{F}_{y}}{{F}_{v}} = \frac{cos {θ}_{1}}{2 sin {θ}_{1}} = \frac{cot {θ}_{1}}{2} \qquad [ Equation 2 ]$$

In FIG. 3B, according to the kinematic theory and the principle of conservation of energy, we get:

Fₓ×vₐ=F_{y}×v_{b} [Equation 3]

Where, F_{y} is the input force, which is in y direction. Fₓ is the equivalent resultant force in piezoelectric materials induced by the input force F_{y}, which is in x direction. Point O is the instantaneous center of the equivalent rigid body AB, and the instantaneous speed of rotation is w. So:

Vₐ=w×l_{y};v_{b}=w×lₓ [Equation 4]

The second amplification ratio can be derived as:

$${R}_{2} = \frac{{F}_{x}}{{F}_{y}} = \frac{{v}_{b}}{{v}_{a}} = \frac{{l}_{x}}{{l}_{y}} = cot {θ}_{2} \qquad [ Equation 5 ]$$

The total amplification ratio of the two-stage amplification structure is

Rₜₒₜₐₗ=R₁×R₂=cot θ₁×Cot θ₂/2 [Equation 6]

t

If θ₁=θ₂=5°, then Rₜₒₜₐₗ≈66. Therefore, the amplification ratio can be very large. This multistage force amplification mechanism increases effective piezoelectric constants significantly.

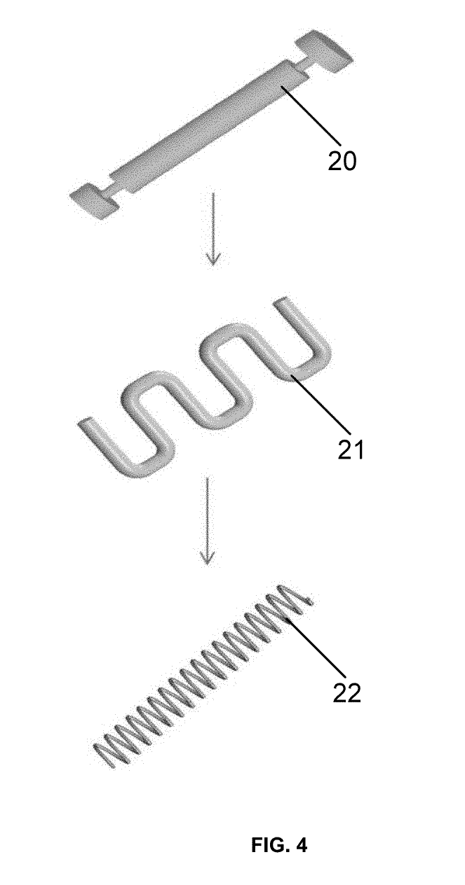

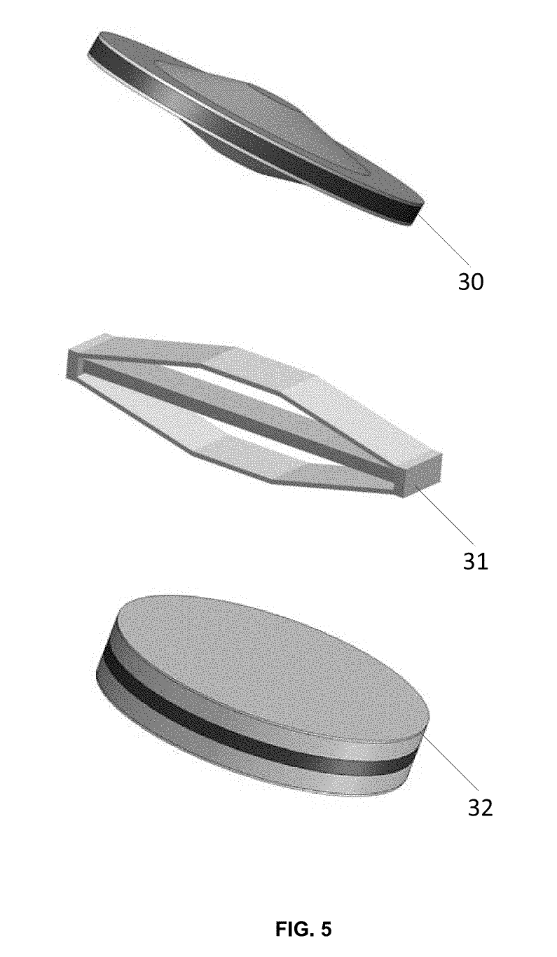

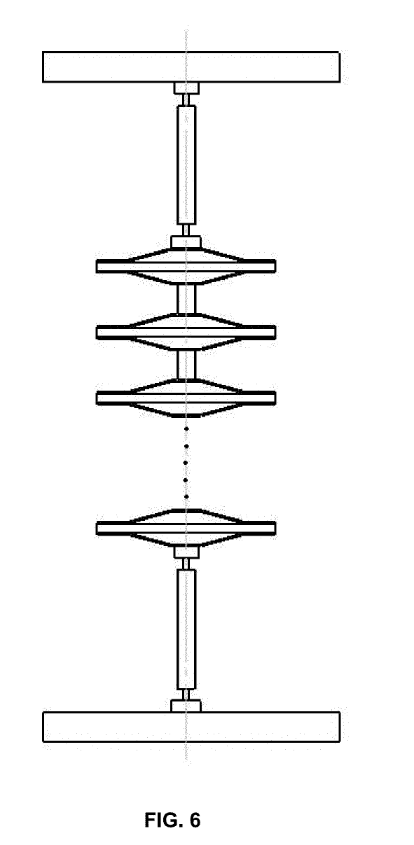

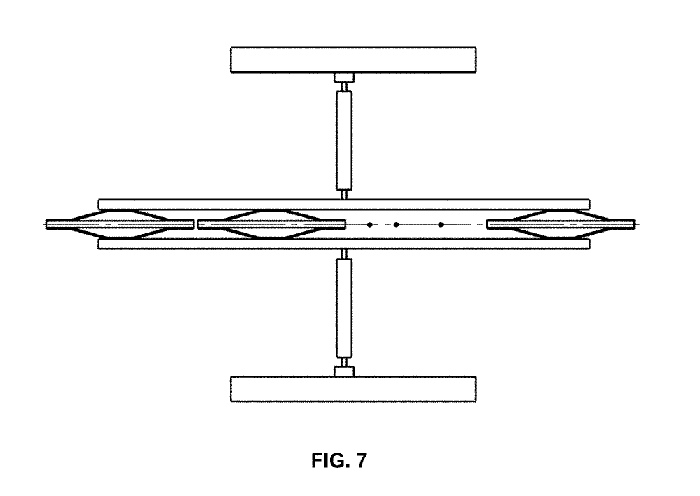

The embodiment of this invention can be changed as follows:
(1) The length of two beams can be different;
(2) Two mass blocks can be any shape to adjust different operation conditions. For example, it may have airfoil shape to harness fluid vibrations;
(3) The compressive or tensile preload force along the beam can be different to get different stiffness coefficient and nonlinear characteristics;
(4) Elastic beam 20 can also have inconsistent width and section along its axial direction. The beam 20 can also be modified to spring 22 or other structure like ‘S’ shape 21 to get different stiffness coefficients, as shown in FIG. 4.
(5) The center flextensional component can be moonie 31, cymbal 30, rainbow, drum 32, etc., those employ same amplification mechanism, as shown in FIG. 5. Different profiles of the flextensional component should be selected according to space constraints. The initial angle of the flextensional component can be positive, zero, or negative. When zero or negative angle appears, two gaskets should be added to the flextensional component in case that unexpected stroke damages piezoelectric materials. The flextensional center can be one-stage or multistage flextensional amplification structure.
(6) Two elastic beams may also be not in parallel, but be at a certain angle to balance gravitational force or to fortify vibrations from a certain direction.
(7) In some situations, there can be more than one flextensional components working in series, as shown in FIG. 6.
(8) In some situations, there can be more than one flextensional components working in parallel, as shown in FIG. 7. Center flextensional components can be set symmetrically or asymmetrically around the elastic beams.
(9) The elastic beams are hinged or fixed to the base. In some cases, elastic cushion can be added between the elastic beam and the base. So the design can absorb axial vibration energy. By elaborately selecting appropriate stiffness of the elastic cushion, the stochastic resonance phenomenon can be achieved, which is believed can improve the performance further.
(10) According to different conditions, the location of the proof mass can be changed to the edge or the dome of the center flextensional component. The aim of adding proof mass is to decrease working frequency and increase induced inertial force. They can be replaced or omitted in some situations too.

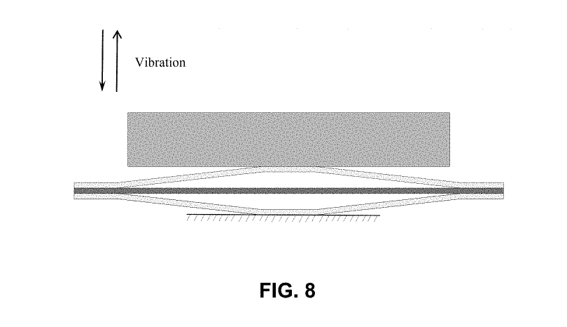

The present device has a broader bandwidth and higher energy output than traditional flextensional energy harvester as shown in FIG. 8. The materials of the component can be modified by any other materials to achieve the same result.

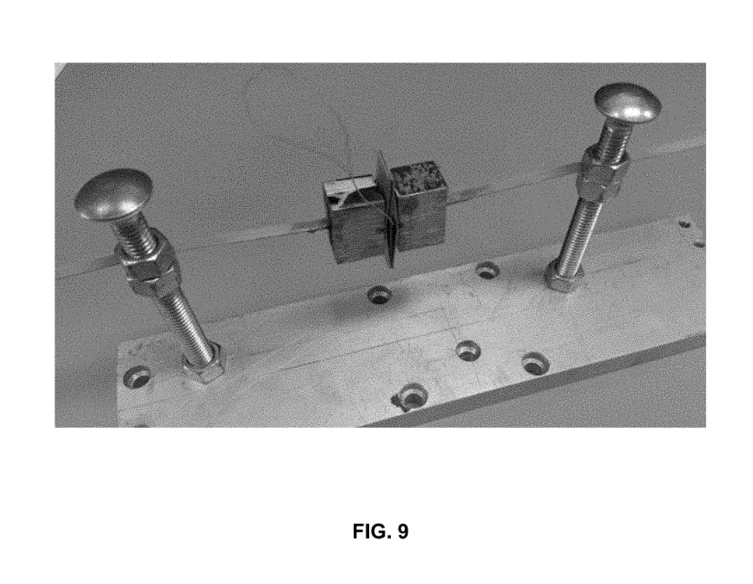

One embodiment of the present devices uses a PZT-5A plate (40×15×0.5 mm) with Piezoelectric constants: d₃₃ 400×10⁻¹² C/N; d₃₁ 180×10⁻¹² C/N; g₃₃ 25×10⁻³ Vm/N; g₃₁ 11.3×10⁻³ Vm/N. FIG. 9 shows the high efficiency vibration-based energy harvester (HVEH). The overall weight of two initial mass blocks is 100 g. The elastic beams are two uniform aluminum beams (50×4×0.38 mm). The beam is fixed to the base and center flextensional component. The center flextensional component consists of a PZT plate, two convex aluminum plates (0.5 mm in thickness). Aluminum convex plates were bonded on the ceramic by epoxy. Specifications of the HVEH are not accurate because it is made by hand and the purpose of this experiment is to validate the HVEH has higher energy output than conventional energy harvester under same conditions. The prototype was tested with low-acceleration (0.5 g) and low-frequency (10-30 Hz) vibrations. The structure was mounted on a vibration shaker. And its output port is connected to a 300 KC) resistance. The output voltage is monitored by an oscilloscope. The energy generated by the HVEH is calculated using the equation: Voltage²/Resistance.

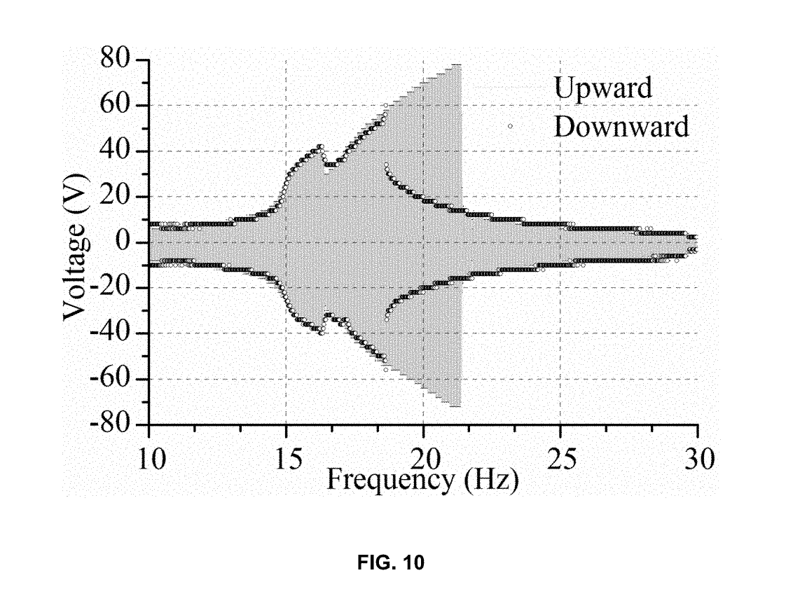

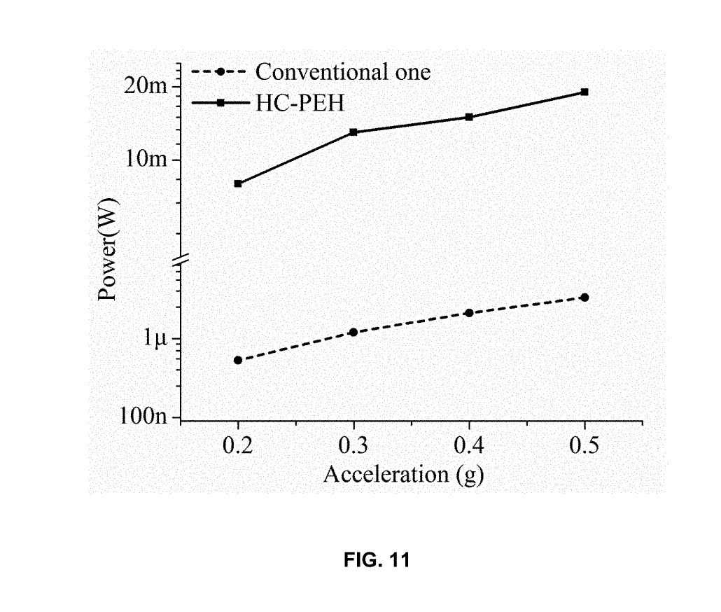

FIG. 10 and FIG. 11 show the results of the comparison experiment between the present invention and the conventional one. As can be seen from FIG. 10, the first resonance frequency of the HVEH is about 21 Hz, which is much lower than the counterpart (over 1 KHz). The HVEH shows a broad working bandwidth and high power output. The maximum power output of the invention is about 19 mW, which is orders of magnitude bigger than that of the conventional energy harvester (about 20 μW). Under such low acceleration and low frequency, most of energy harvesters cannot generate electricity more than 1 mW. The power output of the HVEH: over 10 mW is good enough to power most microelectronics in practical application. However the performance is by no means the best performance because the piezoelectric material we use is PZT-5 Å whose conversion coefficient is not high and the first prototype is made roughly by hand which is believed to introduce great damping and unbalance in the system.

The experiment demonstrates that the present invention has broader bandwidth and much higher energy output. Its superiority is verified. It can harvest much more vibration energy and work at low frequency range. It is promising to be applied in low-frequency environment like implantable devices, health monitoring and wireless sensor systems.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A multi-directional piezoelectric energy transducer system to harvest vibrational energy comprising: a center flextensional component installed between a pair of elastic beams, each said beam having a distal end and a proximal end, wherein said proximal ends being connected to said center flextensional component, and said distal ends being used to install said system onto a base, whereby any vibration of the base excites the center flextensional component and whereby said system increases effective piezoelectric constants.

2. The multi-directional piezoelectric energy transducer system of claim 1, wherein said center flextensional component comprising a piezoelectric element sandwiched between two bow-shaped plates.

3. The multi-directional piezoelectric energy transducer system of claim 1, wherein said bow-shaped plates being connected to said beams through a proof mass, wherein said proof mass being an element having a predefined size and mass, whereby said proof mass being added to tune the natural frequency of the system and capture more inertial energy.

4. The multi-directional piezoelectric energy transducer system of claim 2, wherein said piezoelectric element being selected from the group consisting of a one-layer unimorph, a two-layer bimorph, and a multi-layer stack.

5. The multi-directional piezoelectric energy transducer system of claim 2, wherein said piezoelectric element being selected from the group consisting of piezoceramics, PVDF, single crystal materials, and magnetostrictive materials.

6. The multi-directional piezoelectric energy transducer system of claim 1, wherein said system being excited by the base vibration, or a load on the center flextensional component or the proof mass.

7. The multi-directional piezoelectric energy transducer system of claim 1, wherein said elastic beams, said proof mass and said base being connected by a fix connection, a hinge, or a ball joint.

8. The multi-directional piezoelectric energy transducer system of claim 1, wherein an axial preload being added along each said elastic beam to enhance the performance.

9. The multi-directional piezoelectric energy transducer system of claim 1, wherein said elastic beams having variable shapes.

10. The multi-directional piezoelectric energy transducer system of claim 1, wherein said elastic beam being selected from the group consisting of a metal, a non-metal, and shape memory alloys.

11. The multi-directional piezoelectric energy transducer system of claim 1, wherein said center flextensional component being a rectangular shape or a circular shape.

12. The multi-directional piezoelectric energy transducer system of claim 1, wherein an angle of the bow-shaped plate with the piezoelectric element being changed to be positive, or zero, or negative.

13. The multi-direction piezoelectric energy transducer system of claim 1, wherein a gasket being added between the bow-shaped plate and the piezoelectric element.

14. The multi-directional piezoelectric energy transducer system of claim 1, wherein said piezoelectric element being worked in d₃₁, d₃₃ or d₁₅ mode.

15. A multi-directional piezoelectric energy transducer system to harvest vibrational energy comprising: a plurality of center flextensional components connected in series and installed between a pair of elastic beams, each said beam having a distal end and a proximal end, wherein said proximal ends being connected to a free end of said series of components, and said distal ends being used to install said system onto a base, whereby any vibration of the base excites the center flextensional components and whereby said system increases effective piezoelectric constants.

16. A multi-directional piezoelectric energy transducer system to harvest vibrational energy comprising: a plurality of center flextensional components connected in parallel to a base, each component installed between a pair of elastic beams, each said beam having a distal end and a proximal end, wherein said proximal ends being connected to one of said components, and said distal ends being used to install said system onto the base, whereby any vibration of the base excites the center flextensional components and whereby said system increases effective piezoelectric constant.
